(19) United States
(12) Patent Application Publication
(10) Pub. No.: US 2006/0060689 A1
(43) Pub. Date: Mar. 23, 2006

(54) Collapsible reel

(76) Inventor: Kevin S. Fuller, Centerville, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/234,065

(22) Filed: Sep. 23, 2005

Related U.S. Application Data
(60) Provisional application No. 60/612,333, filed on Sep. 23, 2004.

(51) Int. Cl. B29B 15/00; B65H 75/22

(52) U.S. Cl. 242/607.1; 242/610.6; 264/349; 29/403.1; 264/911; 264/250

(57) ABSTRACT

A collapsible reel for receiving windings of wire or the like includes a pair of opposed flange members and a plurality of folding support members defining the reel core and hingedly attached therebetween. Each of the flange members may include a plurality of pockets for receiving the plurality of folding support members when the reel is collapsed such that the thickness of the collapsed reel is the substantially the thickness of the two flanges. An outward arcuate contour is provided for winding the wire or like. The hinge structures each have a hinge axis and a radially displaced force transfer contact portion whereby compressive loading of the reel is not conveyed through the hinge axis. Interlocking surface structure is on the outside facing surface such as multiplicity of the reel flanges to facilitate stacking. The flanges, the folding core arms, and the hinge structure may all be formed of the same polymeric composition to facilitate grinding of the entire assembled reel for easy recycling.

### RELATED APPLICATION

The present application claims the benefit of U.S. Provisional Application Ser. No. 60/612,333, filed Sep. 23, 2004, included herein in its entirety by reference.

### FIELD OF THE INVENTION

This invention relates to reels and, in particular, this invention relates to reels for wire, cable, conduit and the like, which are collapsible and recyclable.

### BACKGROUND OF THE INVENTION

Reels, sometimes referred to as spools, are commonly used to store, transport, and dispense windable materials, such as cable, wire, conduit, tubing, or the like. These reels commonly have a generally cylindrical core, also known as a drum or hub, defining a winding base flanked by two opposed flange elements. The windable material is wound around the cylindrical core between the flange elements to be efficiently stored, transported, and dispensed. One disadvantage of some reels of the prior art has been that empty reels require essentially the same amount of volume for storage and transport as reels with wound material thereon. Another disadvantage has been that many reels are made from solid materials and are thus often heavy. Heavy reels are more expensive to transport than lighter reels and are more likely to cause workplace injuries because of their greater weights.

Larger diameter, conventional reels, that is greater than 18 inch flanges for holding wire, have until recently, conventionally been made from wood with metal fasteners and are rigid, non collapsible and not readily disassembleable. These reels are difficult to repair and are not generally considered to be readily recyclable.

U.S. Pat. No. 3,791,606 discloses a collapsible cable spool having radially fluted flanges and a plurality of foldable drum or core sectors pivotally carried in the flutes to permit the spool to be collapsed for storage or transport. The collapsed spool occupies considerably less volume than when the spool is in an uncollapsed configuration. However, the drum or core arms extend past the periphery of the flanges when the spool is in an uncollapsed configuration. Moreover, the flanges are spaced apart when the spool is in an uncollapsed configuration, the spool therefore failing to occupy a minimum volume. Additionally there are a large number, ten illustrated, of folding core arm sets as well as utilizing different materials, wood and metal for the reel. Manufacture of this reel thus requires fabricating and assembling a large number of components and repair, disassembly, and recycling would be problematic.

U.S. Pat. No. 5,649,677 discloses a collapsible spool with a pair of opposing side flanges and a plurality of foldable core arms extending therebetween. Each of the foldable core arms fold radially outward for collapsing the spool. The foldable arms of the collapsible spool of U.S. Pat. No. 5,649,677 do not extend past the peripheries of the side panels when in a folded position. However, the flanges are spaced apart in the folded position and hence, the amount of volume occupied by this configuration is not optimal.

U.S. Pat. No. 5,649,677 discloses a spool that has a folding inner core that presents a curved surface in its expanded position. However, this spool does not fold into the optimal 2× the flange thickness, the folded arms take up substantial space between the flanges. Additionally, the disclosed materials and connectors include metals such that recycling by grinding the assembled spool would not be feasible.

U.S. Pat. No. 6,913,222 discloses a collapsible reel that collapses into an optimal space of 2× the flange thickness with three folding core arms nesting into recesses in the flanges. This reel has three separate arms that form the core with each of the arms presenting a flat outer surface for receiving the windings of the wire or other material. This is not an ideal configuration in that the material wound thereon may take this non-cylindrical shape and additional stresses may be imparted to isolated portions of the arms, which are primarily contacted by the windings. This can require reinforcement and strengthening in certain areas of the spool adding weight or could cause early failure of the spool. Additionally, this spool is not entirely made of plastic so recycling and grinding-up an assembled spool would be problematic. As in other prior art plastic reels suitable for wire and the like, tools are presumably necessary for disassembly or removal of metal components prior to grinding for recycling.

A collapsible, easy to assemble spool, is robust, that folds into minimal thickness and that is made entirely of plastic material to facilitate recycling is needed. Moreover, a collapsible spool that folds into a minimal thickness and that presents a curved core for receiving windings is needed.

Another concern with reels with plastic flanges is that when stacked flange to flange, the flanges are generally very slippery with respect to one another. This can create safety issues when transporting or storing folded or unfolded spools as well as spools fully wound or empty spools. A collapsible spool that alleviates this problem would be desirable.

### SUMMARY OF THE INVENTION

This invention substantially meets the aforementioned needs of the industry by providing, in preferred embodiments, a highly robust collapsible reel occupying a minimum of volume when in a collapsed disposition, having a minimum, or reduced, weight, being comprised of recyclable plastic, presenting a winding surface with curved outer surface, providing highly robust hinge connections, and flange configurations that resist sliding when stacked.

The preferred embodiment is comprised of a pair of generally circular flange members connected by a core assembly comprising a plurality of folding core arms. The core arms preferably include a pair of arm segments, which are hingedly connected end-to-end. Each of the segments of the core arms can be configured to a fully extended, substantially straight position, disposed generally orthogonally to the flange members, to present a curved outwardly facing surface about which the windable material can be wound. In a preferred embodiment the curved outwardly facing surface can be provided or enhanced by a split tubular sheath that fits over the expanded core arms.

The flange members and core assemble of the present invention may be designed and adapted to be individually molded. Moreover, all components of the present collapsible reel may preferably be made from a single recyclable polymer (e.g., styrene). Preferred embodiments of the present collapsible reel eliminate the use of metal hinge pins connecting the arm segments to one another to form the core arms and eliminate the use of metal hinge pins connecting the folding core arms to the flanges. Preferably, this is accomplished by a hinge pin molded of the same material as the flanges and core arms, to include a pair of flange members pivotally attached to a plurality of core arms. Using the single material to make the reel components eliminates the need to remove materials such as metal fasteners, pins, or the like prior to grinding and recycling the remainder of the reel. Hence, the present collapsible reel may be easily be put in a grinder without any preparation or disassembly, or use of tools for disassembly, and easily and economically recycled after use.

Each of the flange members may include a plurality of cavities or ribbing for adding strength. When the present reel is in a collapsed disposition, the arm segment pairs are in a folded position, such that each of the pivot arms is received in and accommodated by one of the flange pockets or cavities and such that the flange members are in a generally confronting and contacting relation. In one embodiment, each of the pivot arms displays a first plurality of contact surfaces at a first end thereof and a second plurality of contact surfaces at a second end thereof. When the reel is in an extended position, each of the first plurality of contact surfaces of one arm abuts one of the first plurality of contact surfaces of the second arm. Also when the reel is in an extended position, each of the second plurality of contact surfaces contacts one of the contact surfaces present on the flange members. Preferably the stop surfaces on the ends of the arm segments that engage the flange are generally configured to fall within and define a segment of a circle and lay within a plane. Similarly the contact surfaces between arm segments of each folding core arm may also fall within and define a segment of a circle and are planar. The axis of the hinges between the respective paired arm segments and between the folding core arms and the flanges are positioned at or outside the chord portion of the segment of the circles. An advantage of this feature is that when the reel is axially loaded in the extended position, such as by stacking, the majority of the loading does not go through the hinge axis and pin supporting structure but through the engaged contact surfaces. This facilitates the use of non-metal hinge pins or hinge structure, and such formed of the same plastic material if desired as the flanges and core arms.

It is an advantage of the foregoing feature that the core arms of the present collapsible reel may be disposed in the flange member cavities, such that the flange members are in a contacting disposition and such that a height of the collapsed reel is substantially equal to the combined height of the individual flange members.

It is another advantage of the foregoing feature that the axial forces exerted on the flanges will not tend to collapse the reel. The contact surfaces between the core arms and the flanges may have a slight cant outward from the plane of flange to provide further resistance to collapsing of an expanded reel without any windings thereon.

It is an advantage and feature of the present reel, that when fully collapsed, it has a thickness of about twice the thickness of each individual flange members.

It is an advantage of the foregoing feature that the pivot arms can be disposed within the flanges without extending past the periphery of the flanges when the present reel is in a retracted position, thereby occupying a minimum amount of space.

It is a feature of the present reel that the pivot arms present a generally arcuate outer profile for receiving the material wound on the reel. It is an advantage of this feature that the generally arcuate outer profile of the pivot arms minimizes the potential of damage to the material wound around the reel.

It is a feature of the present reel that the pivot arms are joined to each other and to the flanges with pivot pins that are preferably formed of recyclable plastic.

It is an advantage of the foregoing feature that the hinge or pivot pins may be easily replaced, thereby simplifying repair.

It is a feature of the present reel that the pivot pins include a detent assuring that the pivot pin remains in their respective hinge joints.

It is another feature of the present reel that the totality of the reel can be made from a single, recyclable thermoplastic injection molded material.

It is an advantage of the foregoing feature that the present reel can be easily recycled without the necessity of disassembling the reel or of removing components that cannot be recycled or that would be an impurity to the recycled other portions of the spool.

These and other objects, features, and advantages of this invention will become apparent from the description that follows, when considered in view of the accompanying drawings.

Another aspect of the invention is that all components are injection molded and there only needs to be a minimal number of molds in that the reel is comprised of several identical components. For example, both flanges are identical and may be formed from a single mold and the core arms are identical.

In preferred embodiments, the outwardly facing surface of the flanges have structure that slidingly interlocks with an engaged same structure of a like reel stacked therewith. Such structure may be, for example, a multiplicity of peaks and valleys to provide a multiplicity of cam surfaces to resist but not prevent sliding.

### BRIEF DESCRIPTION OF THE DRAWINGS

FIG. 1 is a perspective view of the present collapsible reel in an extended position;

FIG. 2 is another perspective view of the present collapsible reel in an extended position;

FIG. 3 is a perspective view of the present collapsible reel intermediate between an extended position and a retracted or collapsed position;

FIG. 4 is a perspective view of the present collapsible reel in a retracted position;

FIG. 5 is a plan view of a flange of the present collapsible reel;

FIG. 6 is a perspective view of a pair of pivot arms of the present collapsible reel;

FIG. 7 is an end view of one of the pivot arms of FIG. 6;

FIG. 8 is a perspective view of the present reel depicting a pair of pivot arms pivotally joined to a flange element;

FIG. 8A is a cross-sectional view of one of the retaining elements of FIG. 8;

FIG. 9 is a perspective view of a pair of joined pivot arms;

FIG. 10 is a perspective view of one embodiment of a pivot pin used to join the pivot arms of FIG. 8; and

FIG. 11 is a perspective view of another embodiment of a pivot pin used to join the pivot arms of FIG. 8 to a flange element.

FIG. 12 is an exploded view showing a spool and a rigid openable form for fitting around the core arms intermediate the flanges.

FIG. 13 is a closeup perspective view of planar knurling on the surface of the flanges illustrating an aspect of the invention.

FIG. 14 is a perspective view of an embodiment of the invention on a stand with an axle for dispensing wire on the reel.

FIG. 15 is an elevational view of alternative mateable hinge structures.

FIG. 16 is a cross-section of suitable interlocking surface for flanges for limiting sliding of stacked or abutted reels.

FIG. 17 is a cross-section of an alternative interlocking surface configuration.

FIG. 18 is a cross-section of two flange surfaces engaged.

It is understood that the above-described figures are only illustrative of the present invention and are not contemplated to limit the scope thereof.

### DETAILED DESCRIPTION OF THE INVENTION

Any references to such relative terms as inboard and outboard, right and left, inner and outer, and the like are intended for convenience of description and are not intended to limit the present invention or its components to any one positional or spatial orientation. “Substantially” when used herein also includes exactly the characteristic or relationship referenced. All dimensions of the components in the attached figures may vary with a potential design and the intended use of an embodiment of the invention without departing from the scope of the invention. Each of the additional features and methods disclosed herein may be utilized separately or in conjunction with other features and methods to provide improved connectors and methods for making the same. Representative examples of the teachings of the present invention, which examples utilize many of these additional features and methods in conjunction, will now be described in detail with reference to the drawings. This detailed description is merely intended to teach a person of skill in the art further details for practicing preferred aspects of the present teachings and is not intended to limit the scope of the invention. Therefore, only combinations of features and methods disclosed in the following detailed description may not be necessary to practice the invention in the broadest sense, and are instead taught merely to particularly describe representative and preferred embodiments of the invention.

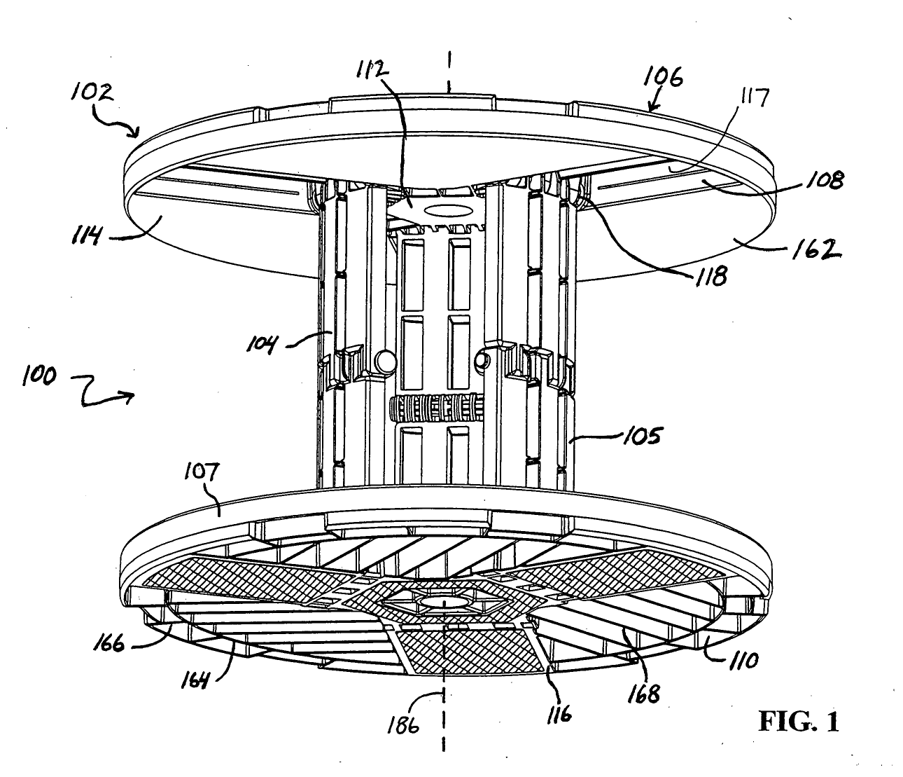

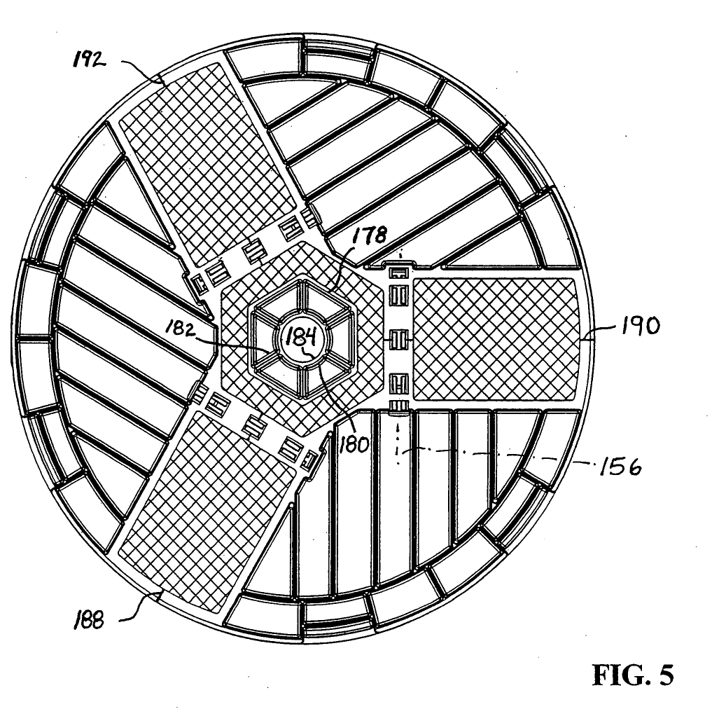

Referring to FIGS. 1-5, a preferred embodiment of a collapsible reel of the present invention is depicted in the figures generally at 100, has an axis a_{R} and includes a pair of substantially identical flange members 102 and a plurality of (e.g., three) support units or folding core arms 104 or hub portions that define a hub or core assembly that constitutes a winding base 105.

Each of the flange members 102 has a flange axis a_{F} defines a rim 106 having a cylindrical outer surface 107 that extends circumferentially. Each flange member unitarily (or otherwise integrally) further includes a plurality of respective first or inward cavity portions 108 and second or outward cavity portions 110 which preferably alternate circumferentially around each flange, a central portion 112, and displays respective inboard and outboard sides 114 and 116.

For example, from 0 to approximately 30° extending around circumferentially around the periphery of a first side of a flange, the first or inward cavity portion 108 have the ribs, which are generally planar are axially extending, exposed and open toward the first side as are the cavities they define; from 30 to 120°, the ribs again extend axially but are exposed and open to the second side as are the cavities they define. From 120° to 150°, the ribs and cavities they define are exposed and open to the first side; and so on.

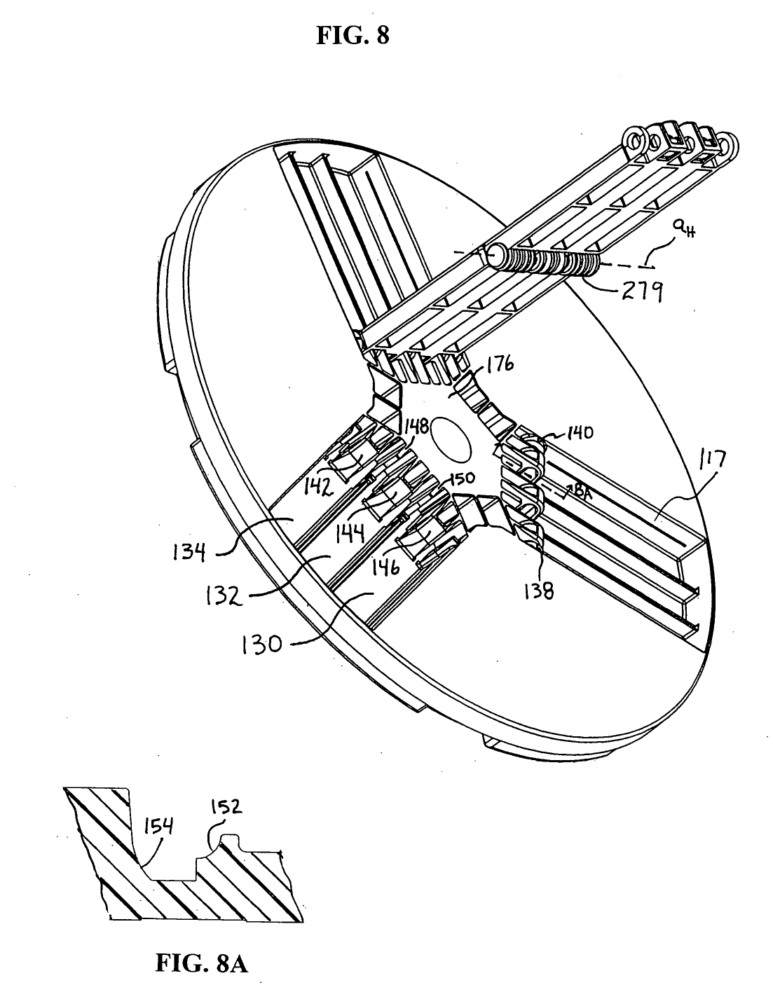

As also more fully explained below, each of the receiving regions 117 configured as inward cavity portions 108 pivotally accommodates an element of one of the core arms 104. Each of the inward cavity portions 108 includes a hinge structure 118, an outboard panel or portion 120, and a cavity such as defined by the panelar portion 120, ribbing 122 and 124, and sides 126 and 128, the ribs and sides extending in an axial direction with respect to the flange and reel. In the embodiment depicted, the panelar portion 120, ribbing 122 and 124, and sides 126 and 128 are unitarily molded and thus are integral to the rim 106. The sides 126 and 128 of the inward cavity portion also extend from the second units 110 in a manner more fully explained below. The panelar portion 120, ribbing 122 and 124, and sides 126 and 128 further subdivides each of the cavities into pockets 130, 132, and 134, which are best seen in FIG. 8. In preferred embodiments, each flange, in an axial direction, is at least ¾ inch in thickness from one side to the other and the axial length of the winding base defined by the folding core arms is at least 5 inches in length.

Referring to FIGS. 1, 2, 5, 8 and 8A, the hinge structures 118 includes arch members 138, 140, 142, 144, and 146 and retaining elements 148 and 150. The arch members 138 and 140 integrally extend from the respective sides 128 and 126 and the arch members 142, 144, and 146 integrally extend from the panelar portion 120. Each of the arch members 138-146 defines an opening generally aligned along an axis 156. The retaining elements 148 and 150 also extend from the panelar portion 120 and are substantially identical to one another in the embodiment depicted. Each of the retaining elements 148 and 150 defines respective first and second arcuate surfaces 152 and 154. Windows 157 and 158 are defined in the planar member 120 beneath arch members 138 and 140 and windows 159, 160, and 161 are defined in the planar member 120 beneath the arch members 142, 144, and 146, respectively. The windows facilitate injection molding.

Each of the second outward cavity portions 110 provides structural rigidity to the present reel and have a generally panelar portion 162 fully exposed facing inwardly. An arcuate element 164 and ribs 166 and 168 extend from the planar member 162. The arcuate element 164 is disposed generally equidistantly from the rim 106. The ribs 166 are generally equally spaced apart and extend radially between the rim 106 and the arcuate element 164. The ribs 168 are also generally equally spaced apart. The ribs 168 extend generally perpendicularly between the first unit side 126 and the arcuate element 164 or extend at an acute angle between the side 128 and the arcuate element 164.

The central portion 112 broadly includes a panelar portion 176, a polygonal outer portion 178, a generally circular inner bearing portion 180, and a plurality of ribs 182. In the embodiment depicted, the panelar portion 176 is generally coextensive with the first element panelar portion 120 and the outer portion 178. Inner bearing portion 180, and ribs 182 extend from the panelar portion 176. In the embodiment depicted, the outer portion 178 is generally hexagonal and the inner portion 180 is coaxially disposed with respect to the outer portion 178. The inner portion 180 defines an opening 184. When assembled with the plurality of core arms 108, the openings 184 of the two joined flanges are aligned along an axis 186 which is coincident with the reel axis aᵣ. The ribs 182 extend between the inner portion 180 and the apexes of the sides of the outer portion 178.

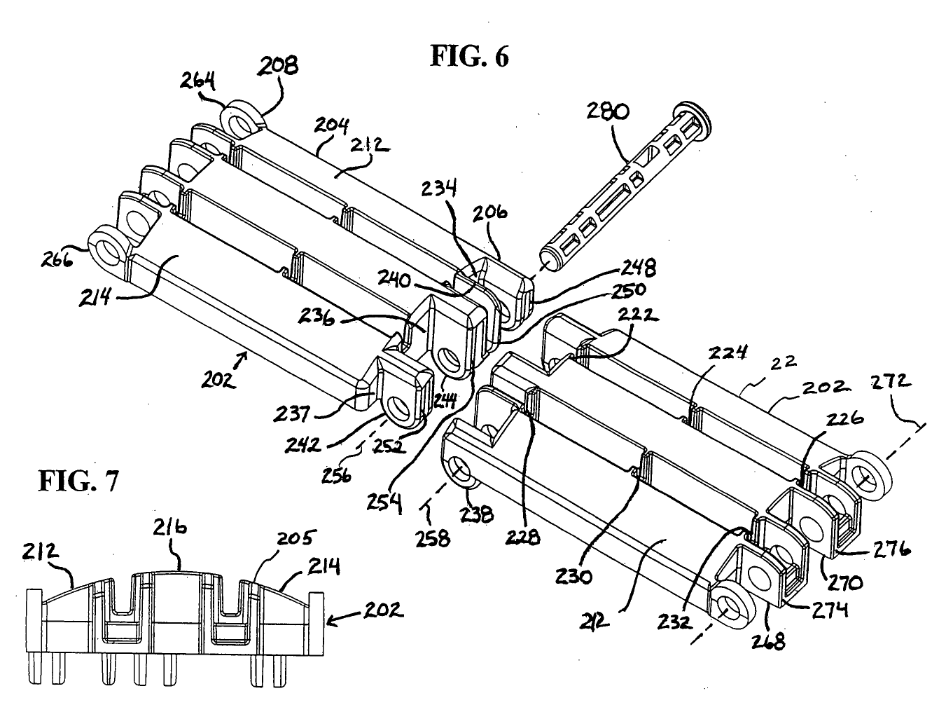

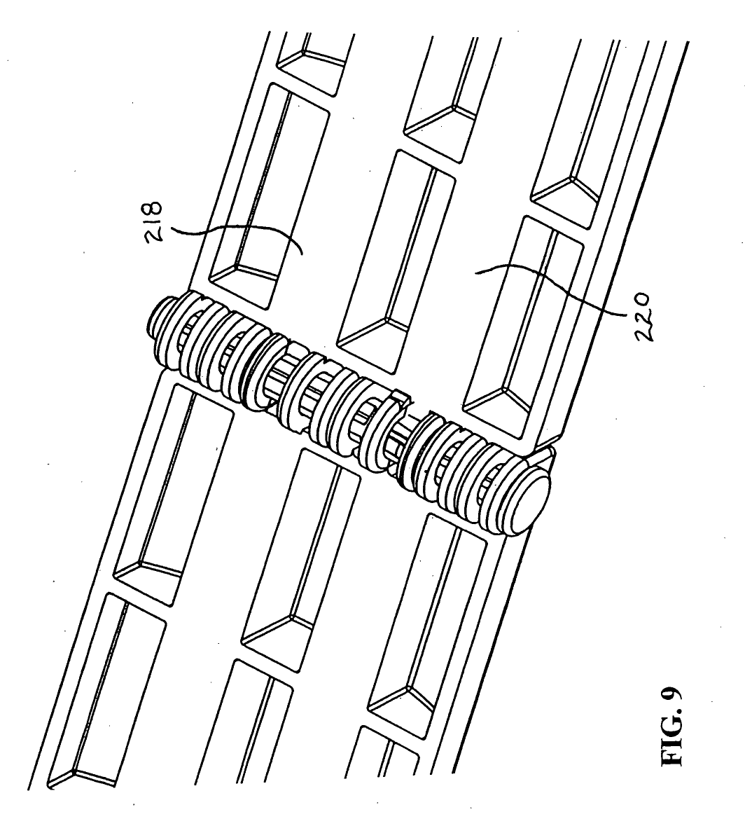

Each of the collapsible core arms 104 is substantially identical in this embodiment and includes two substantially identical pivot arms or arm segments 202. As seen in FIGS. 6-9, each of the arm segments 202 have a body portion 204 integrally joined to respective first and second end hinge connecting structures 206 and 208.

The arm segments 202 have a curvilinear upper side 205, arcuate in the cross-section, and portions of the lower side of the body portion are generally planar as best seen in FIG. 7. The arm segments 202 may be considered to include lateral elements 212 and 214 and a generally central element 216. The lateral elements 212 and 214 and the central element 216 present a generally arcuate contour, the significance of which is discussed more fully below. Continuing to refer to FIGS. 6-9, a bridge element 218 connects the lateral element 212 to the central element 216 and a bridge element 220 connects the lateral element 214 to the central element 216. A plurality of (e.g., three) structures aligningly extend between the lateral elements 212 and 214 and the central element 216 to define gaps 222, 224, and 226 between the lateral element 214 and the central element 216 and gaps 228, 230, and 232 between the lateral element 212 and the central element 216. The gaps 222-232 are dimensioned to accommodate the reel ribbing 122 and 124. Likewise, the lateral elements 212 and 214 and the central element 216 are also dimensioned to be accommodated in the pockets 130-134. The bridge elements 218 and 220 present aligned, generally planar lower surfaces. The ends of the lateral elements 212 and 214 and the central element 216 proximate the first connecting structure 206 present contact surfaces 234, 236, and 237.

The first connecting structure 206 includes extensions 238 and 240 from lateral element 212, extension 242 from lateral element 214, and extension 244 from central element 216. The extensions 238-244, in turn, present respective contact surfaces 248, 250, 252, and 254. The extensions 238-244 have generally rounded bottom portions and define aligned openings along an axis 258. The extensions 238-244 are disposed and dimensioned such that extension 242 of a first arm segment 202 is accommodated between extensions 238 and 240 of a second arm segment 202 and extensions 240 and 244 of the first arm segment are disposed between extensions 242 and 244 of the second arm segment when the first and second pivot arms are meshed such that the axes 258 of each are coextensive. When the axes 256, 258 of meshed first and second pivot arms are coextensive, the extension contact surfaces abuttingly contact the arm segment body contact surfaces when the connected first and second pivot arms are in an extended position. Stated otherwise, when the connected first and second pivot arms are in an extended position, extension contact surface 248 abuttingly contacts arm segment contact surface 237, extension contact surfaces 250 and 254 abuttingly contact arm segment contact surface 236, and extension contact surface 252 abuttingly contacts arm segment contact surface 234. These contacts are generally offset radially with respect to the reel axis a_{R} from the three hinge axes a_{H} of each folding core arms 104. This contact extends linearly in a radial direction, normal to the extended pivot arm, a substantial portion, e.g. great than 50% of the radial thickness of the hinge structure at that point of both pivot arms 200 of each core arm.

The second connecting structure includes lateral extensions 264 and 266 and central extensions 268 and 270. Each extension 264-270 defines a bore, the defined bores generally aligned along an axis 272. The extensions 268 and 270 present respective contact surfaces 274 and 276. The extensions 264-270 are dimensioned and disposed such that extensions 264 and 266 fit inside arch members 138 and 140, respectively, and such that the extensions 268 and 270 at least partially surround the arch members 144 and 146, respectively. The extensions 268 and 270 are further configured such that the contact surfaces 274 and 276 abuttingly contact the generally flat surfaces of the notches 154 when the connected first and second pivot arms 202 are in the extended position. Again this contact extends linearly in a radial direction.

As best seen in FIGS. 8-11, the first and second pivot arms 202 of the core arms 104 are pivotally connected at a hinge 279 having an intermediate hinge axis a_{H} using a connector, such as a pivot pin 280. The pivot pin 280 includes a head 282 unitarily (or otherwise integrally) connected to a shaft 284. In the embodiment shown, the head 282 has a generally disk-like configuration. The shaft 284 may display a generally tapering end 286 distal from the head 282 and may include a detent 288. The detent 288 curves away from a surface of the shaft 284, but may be aligned therewith when a force is exerted radially toward the shaft surface, as indicated by the arrow 290.

Arm segments 202 may also be pivotally connected to the present flange member by a connector such as the pivot pin 280, or by another connector such as a pivot pin 294. The pivot pin 294 has a head 296 with a flat circumferential surface 298. The surface 298 represents a generally planar deviation from the otherwise circular circumference of the head 296.

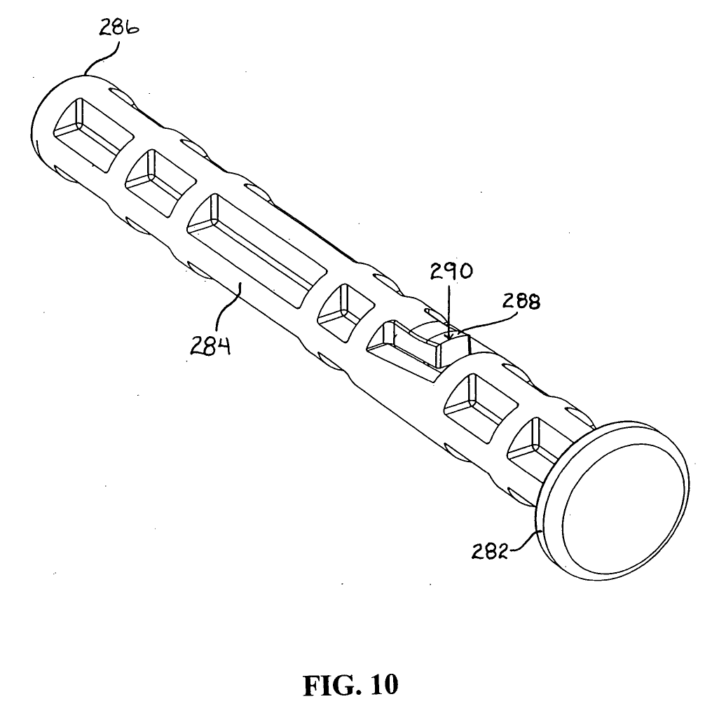

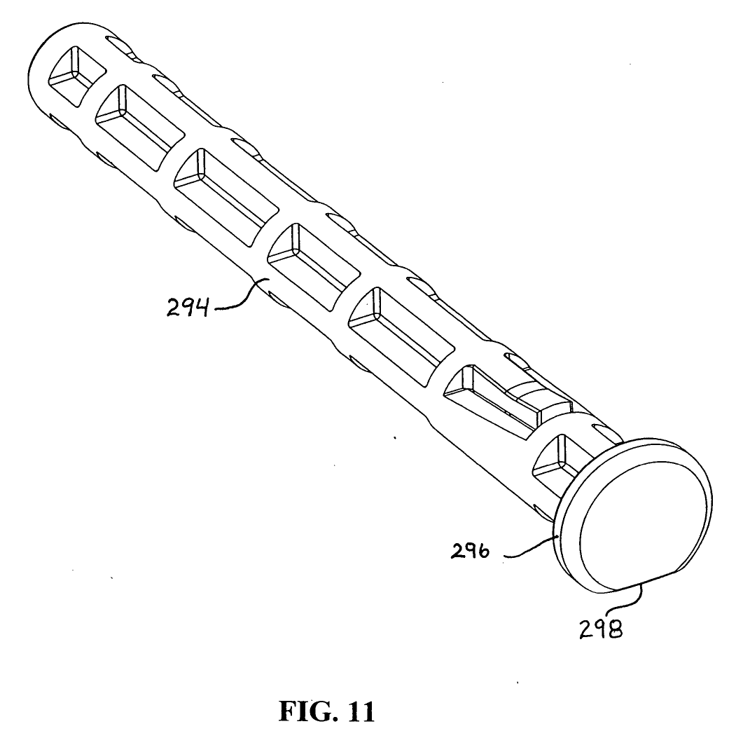

As best shown in FIG. 6, the first and second pivot arms 202 are pivotally connected (e.g., mated) by meshing the first connecting structure extensions 238-244, as described above, such that the axes 258 of each first connecting structure are coextensive and define the hinge axis a_{H}. Inserting a connector such as the pivot pin 280 through the openings defined in the extensions 238-244 completes the connection. When the pivot pin 280 is completely inserted, the detent 288 (shown in FIG. 10) is forced toward the pivot pin shaft surface, thereby further securing the pivot pin 280 in place. The second connecting structures 208 of the connected pivot arms 202 are meshed to each of the flange members 102 by disposing the second connecting structure extensions 264-270 about the arch members 138-146, as described above, and such that each of the axes 272 are coextensive with one of the flange member connecting structure axes 156. The meshed arm segment second connecting structures 208 are pivotally secured to the reel connecting structure 118 by inserting a connector, such as the pivot pin 294 through the generally aligned openings, the pivot pin 294 then being generally coaxial to the axes 156 and 272. In some embodiments, the pivot pin 294 is positioned such that the flat surface 298 (shown in FIG. 11) is disposed proximate the reel second unit planar member 162 to provide clearance between the head 296 and adjacent flange element surfaces.

Referring to FIG. 15, in other embodiments the separate hinge pins may be eliminated by incorporating hinge pin segments 317 as part of the hinge structure of the arm segments 319 to be inserted into apertures 321 in another arm segment or the hinge structure 323 of a flange.

When two opposing flange members 102 are connected by a plurality (e.g., three) of wire winding core arms 104, the present reel 100 (depicted in FIGS. 1-5) is completely assembled and ready for use. As illustrated in FIG. 12, a further form 310 made from cardboard, fibrous material, or rigid plastic, including abs, or the like may be assembled on the core arms to provide a near perfect cylindrical curvature to wind the wire on. The form may be opened at the ends 312 to be placed on the support members. The split cylindrical form may be secured on the core arm by tape or on other securement, i.e. plastic tie. Other configured forms, such as spiralized, may be utilized on the support members also. The form may be made of the same polymer as the flanges and folding core arms.

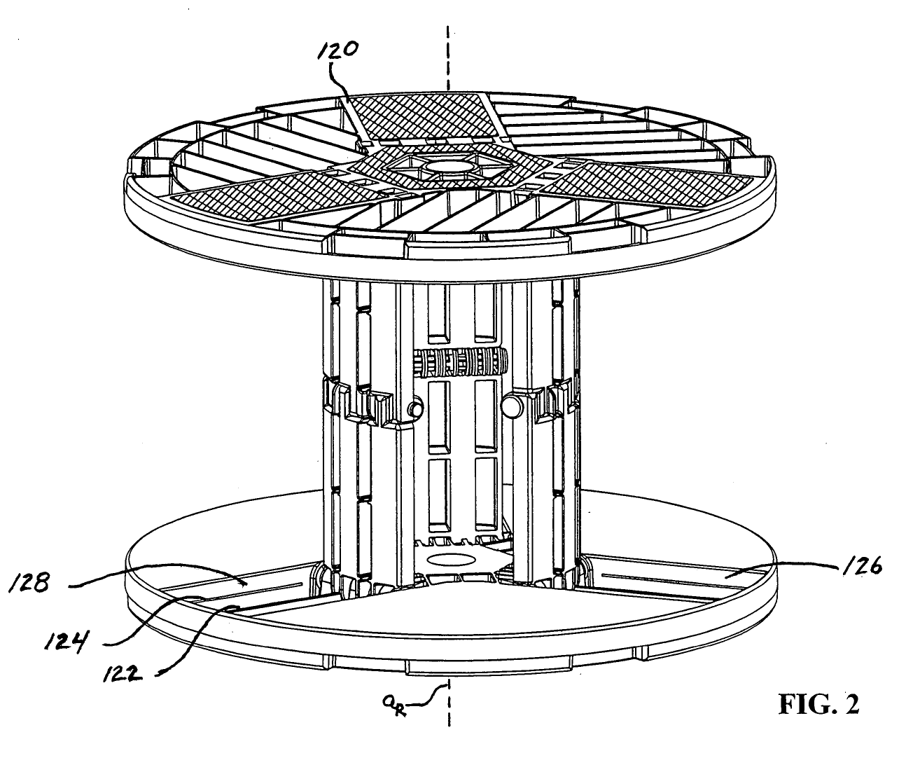

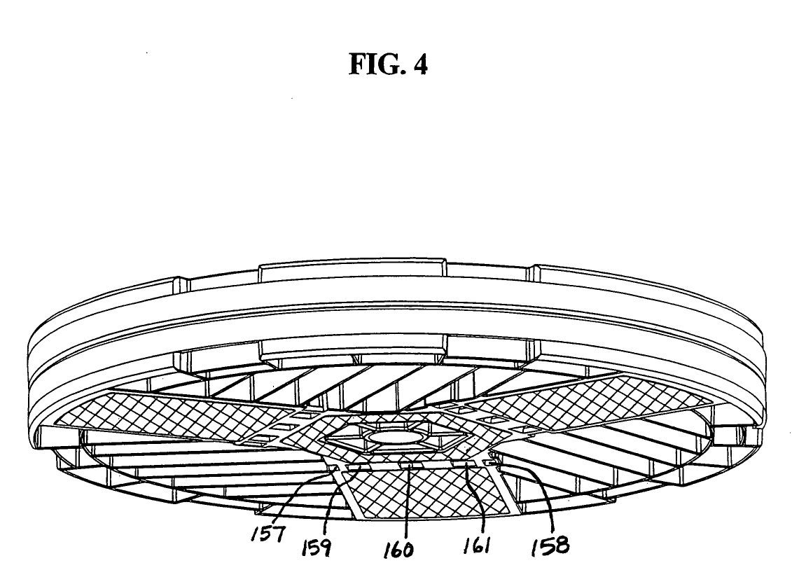

The present reel may be collapsed in a retracted position (depicted in FIG. 4) to minimize the volume required for storage and transport or in an extended position (depicted in FIGS. 1 and 2) for use. In the retracted position, the pivot arms 202 are folded such that the reel first unit pockets 130-134 accommodate them and such that the arm segment bridge elements 218 and 220 of the present connected pivot arms are in contact. When the present reel is in the retracted position, the inboard sides 114 of the opposed flange members 102 are proximate, e.g., in a contacting relation, as well.

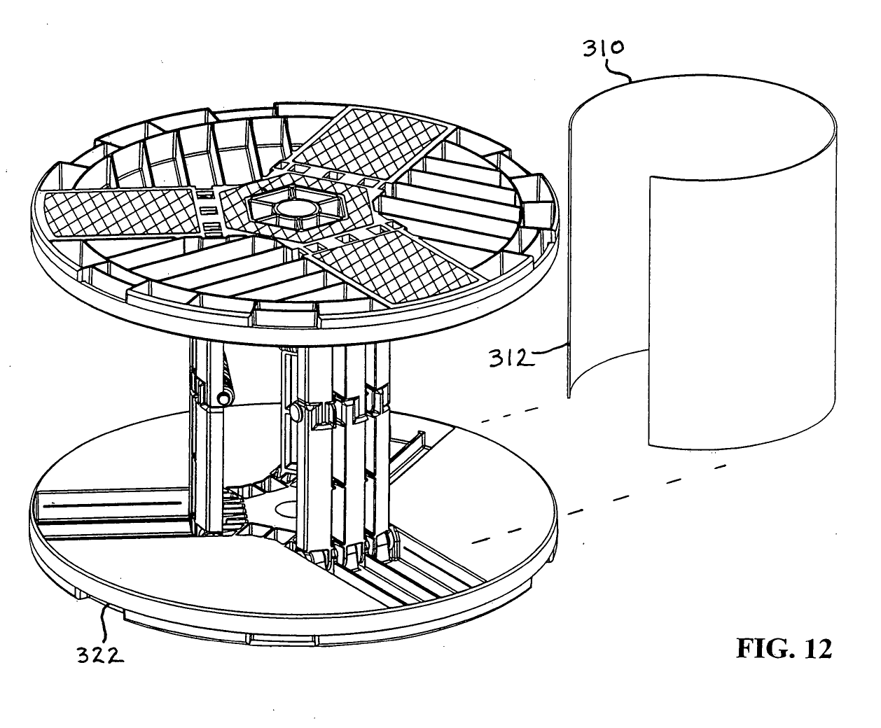

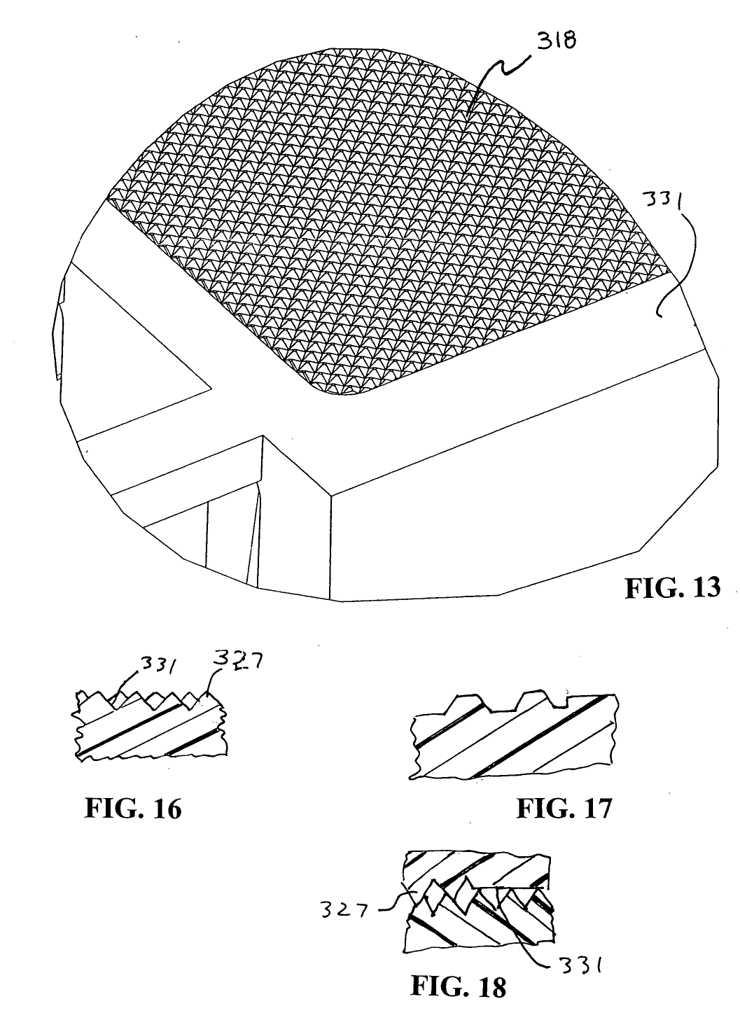

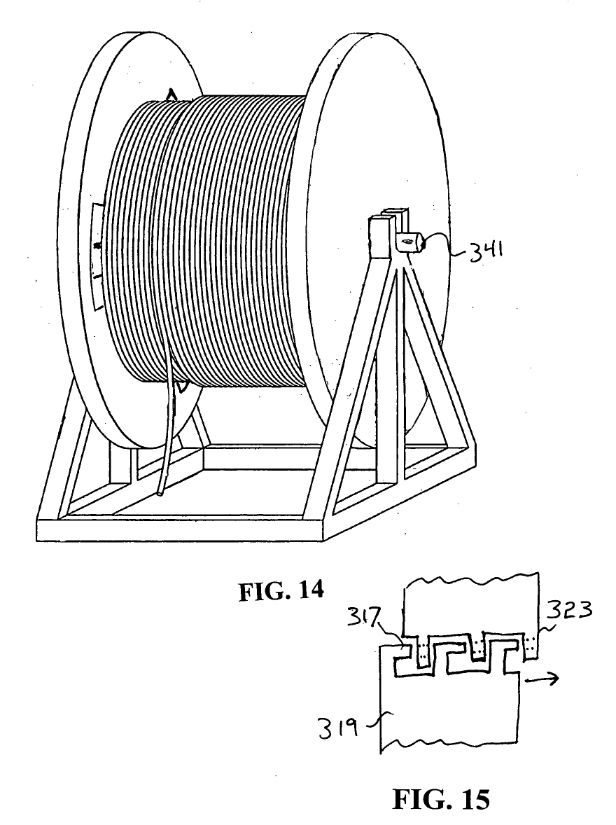

Referring to FIGS. 13, 15, 16, and 17, the exterior exposed sides of the flange members may have surfaces configured to minimize slipping. This can constitute interlocking structure with roughened or textured surfaces 318 that cooperate with an adjacent surface on a stacked or abutting reel to prevent slippage between the reels, either in the expanded or the retracted position. A repeating multiplicity of peaks 327 and valleys 329 where the peaks extend slightly above the adjoining flat surface 331 of the flange. Thus the apexes of the peaks extend out from the nominal surface of the flange. Other interlocking structure may also be quite suitable, particularly structure that has repeating pattern that interlocks with the same pattern on the adjacent reel, see FIG. 17. Additionally recesses 322, as shown if FIG. 12, in the exteriorly facing sides of the flanges may be utilized as hand grips for picking up the spools, either when stacked with other spools or when on a flat surface.

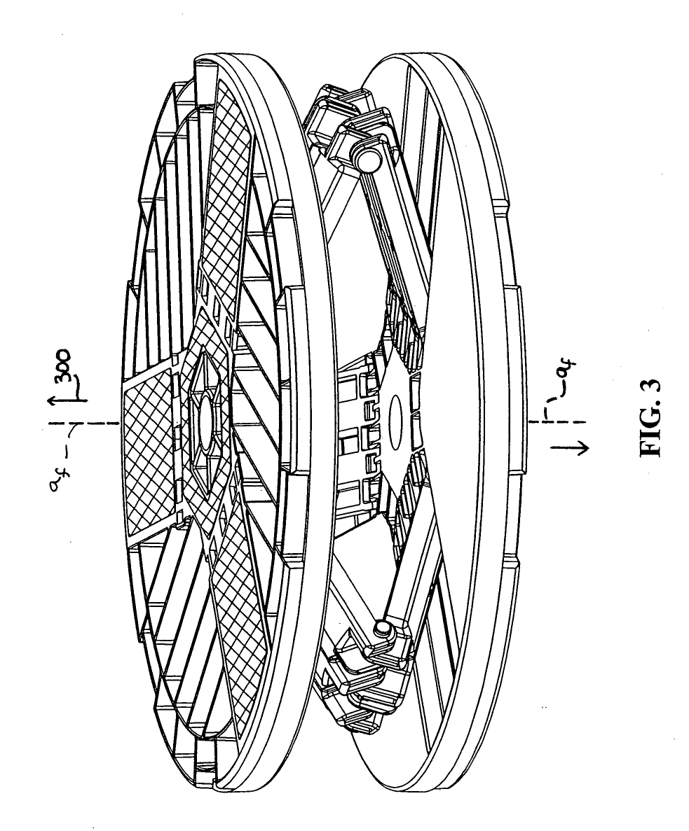

The present reel may be reconfigured from the retracted position to the extended position before being used to store and dispense windable materials, such as chain, wire, cable, rope, tubing, conduit, and the like. The reel 100 is reconfigured from the retracted to the extended position by forcing the opposed flange members 102 apart in directions depicted by arrows 300 (see FIG. 3), thereby pivoting the attached core arms into an extended position. When in the extended position, the attached pivot arms 202 are generally aligned and are generally perpendicular to the flange members. Also, the arm segment first connecting structure surfaces 234, 236, and 237 are in abutting contact with the extension surfaces 248-254, as described above and the second connecting structure surfaces are in abutting contact with the reel contact surfaces 154. One advantage of the foregoing abutting contact between these surfaces is that substantially all of the axial forces exerted on the extended pivot arms are transmitted directly to the reel flange members without tending to fold the pivot arms from the extended position toward the retracted position. Another advantage is that the forces exerted on the pivot pins are minimized.

Referring to FIG. 14, the present reel in the extended position may be used to store, transport, and dispense windable materials. These materials are wound about the core arms, preferably on a form, between the flange members. In one protocol, an axle 341, supported by a stand 343, is inserted through the flange member openings 184, such that the axle coextends the axis 186. One end of the windable material is then secured to one of the core arms 104, and the material is then wound around the core arms as the reel is rotated. The generally curved configuration of the pivot arms may generally follow a circular pattern about the reel axis 186 to provide a generally smooth circular surface (path) about which to wind the materials. Normally, sharp departures from a circular contour would cause the material to be wound, kinked, or bent sharply when forced over the noncircular contours. Thus, the curved surface of the pivot arms provides fewer stress points on the material being wound thereon, thereby eliminating or greatly minimizing kinks and weakened areas in the material. This also minimizes localized stresses, for example, on the edges of the folding core arms.

Materials stored on the present reel are dispensed, e.g., by extending the axle 343 through the reel openings 184 as described above, then unwinding desired amounts of the material from the present reel. When all of the materials are dispensed, the reel can then be configured in the retracted position as described above so that a minimum of volume is required for transport and storage.

Various polymers may be suitable for the invention, for example, acrylonitrile butadiene styrene (abs), other styrenes, polyethylenes such as high density polyethylene, and polypropylene, optionally with a blowing agent, may be used to manufacture the present reel in an injection molding process known to persons of ordinary skill in the art. Additives may also be incorporated into the resin to enhance specific physical properties desired for a given embodiment.

The reel as disclosed is particularly conducive to recycling. A suitable life cycle of these reels could be:

injection molding multiple flanges and multiple folding core arms from the same plastic;

assembling the flanges and folding core arms into collapsible reels without using metal, for example with injection molded hinge pins;

providing, if desired a carved surface for the windings, such by the tubular form;

winding wire or other windable material on said reel;

transporting said reels with windable material thereon to places of usage;

utilizing all of the windable material on individual reels;

collapsing the reels and transporting them for reuse:

reusing the collapsible reels;

grinding the reels with out any disassembly of the reels;

reusing the plastic from the recycled reels.

A person of ordinary skill in the art can readily identify other synthetic resins with characteristics more suitable to other embodiments. Such resins are identified, for example, in the Handbook of Plastics, Elastomers, and Composites, Third Edition, Charles A. Harper, Editor in Chief, McGraw-Hill, New York, N.Y. (1996), hereby incorporated by reference. In one embodiment, all components of the present reel are made from a single resin, such as polypropylene or styrene, without any components being made from other materials, such as metals, wood, or the like. In this embodiment, the entire reel may be efficiently ground-up and recycled, without the necessity of removing components made from either non-resins or other resins.

U.S. Pat. No. 6,913,222 B2 illustrates alternative or additional structure and features consistent with the inventions herein. The U.S. Pat. No. 6,913,222 is incorporated herein by reference.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A collapsible polymer recyclable reel having an extended position and a collapsed position, the reel comprising;
a pair of opposing flanges connected by a core assembly; plurality of folding core arms;
each core assembly comprising a plurality of folding core arms, each folding core arm comprising a pair of hinged arm segments that are foldable from an extended position where the arm segments are substantially aligned end to end and a folded position whereby each arm segment lays alongside each other, each folding core arm further comprising two ends with hinge structure at each end;
each flange having an axis, an axial thickness, a substantially cylindrical outer periphery, an inboard side, an outboard side, and a plurality of core arm receiving regions extending generally radially outward, each receiving region open on the inboard side, the flange comprising hinge structure proximate each of said core arm receiving regions and connected to one of said folding core arms;
and wherein when the reel is in the collapsed position, the arm segments are nested within the arm segment receiving regions and the axial thickness of the reel is substantially the thickness of the total of the two flanges.

2. The collapsible polymer recyclable reel of claim 1 wherein each folding core arm, when in the extended position, has a length, a radially inward side and a radially outward side and wherein the radially outward side has a curvature extending along the length of the folding core arm, said curvature having a radius parallel to the radius of the reel.

3. The collapsible polymer recyclable reel of claim 2 wherein the radius of the curvature is less than a radius of the outer periphery of one of the two flanges.

4. The collapsible polymer recyclable reel of claim 1, further comprising a split tubular form openable for placement on the core assembly, whereby when said tubular form is positioned around the core assembly with the reel in the expanded position, the tubular form provides a cylindrical surface for winding wire or other windable material.

5. The collapsible polymer recyclable reel of claim 4, wherein said form is comprised of a composite of fibrous material.

6. The collapsible polymer recyclable reel of claim 1 further comprising a plurality of polymer hinge pins connecting the plurality of folding core arms to the pair of flanges.

7. The collapsible polymer recyclable reel of claim 7 wherein the hinge pins, the pair of flanges, and the core assembly are all formed of a single polymer.

8. The collapsible polymer recyclable reel of claim 1 wherein the outboard side of each flange has a plurality of radially extending panelar sections which are positioned adjacent the core arm receiving regions.

9. The collapsible polymer recyclable reel of claim 8 wherein each of the plurality of radially extending panelar sections comprise a multiplicity of peaks and valleys, said peaks and valleys engageable with panelar sections of a like reel when said reels are in a stacked flange-to-flange arrangement thereby providing an engagement resistant to sliding.

10. The collapsible polymer recyclable reel of claim 1 wherein the outboard side of each flange has a panelar portion orthogonally positioned to the reel axis that has undulating structure configured to engagingly interlace a panelar portion on a like reel where the two reels are in a flange-to-flange stacked arrangement.

11. The collapsible polymer recyclable reel of claim 1 wherein each folding core arm when in the extended position has a length and has an outwardly facing curvature with a radius of curvature parallel to the length of the core arm, and a plurality of recesses extending lengthwise on each of said core arms.

12. The collapsible polymer recyclable reel of claim 1 wherein the hinge structure of the ends of each folding core arm has a plurality of substantially radially extending contact surfaces portions that engage the respective flanges when in the reel is in the expanded position, each of said radial extending contact portions having a radial length and a width with the radial length substantially greater than said width and wherein the plurality of substantially radially extending contact portion of each end are of at least two different radial lengths.

13. The collapsible polymer recyclable reel of claim 12 wherein the hinge structure of the ends of each folding core arm also comprises a plurality of substantially circumferentially extending contact surface portions having a length substantially greater than a width of said contact surface portions.

14. A method of utilizing and recycling reels for wire or other windable material, the method comprising the steps of:
a) injection molding multiple flanges and multiple folding core arms from the same plastic;
b) assembling the flanges and folding core arms into collapsible reels without using metal;
c) winding wire or other windable material on said reel;
d) transporting said reels with windable material thereon to places of usage;
e) utilizing all of the windable material on individual reels;
f) collapsing the reels and transporting them for reuse:
g) reusing the collapsible reels;
h) grinding the reels with out any disassembly of the reels; and
i) reusing the plastic from the recycled reels.

15. The method of claim 14 further comprising the steps of:
injection molding a multiplicity of hinge pins; and
assembling the flanges and folding core arms utilizing the injection molded hinge pins.

16. The method of claim 15 further comprising the step of installing a split tubular form on the expanded reel before performing step c).

17. The method of claim 16 further comprising the step of removing the split tubular form after performing step e).

18. The method of claim 14 further comprising the steps of:
forming panels having stacking undulations on outboard faces of the flanges during the injection molding.

19. A method of making a collapsible recyclable reel, the reel comprising a pair of opposing circular shaped flanges and a plurality of folding core arms defining a winding receiving base extending between the flanges, the method comprising the steps of:
injection molding a plurality of reel flanges with including cavities for receiving a folding core arm;
injection molding a plurality of arm segment pairs for constructing a plurality of folding core arms, each of said pair of arm segments comprising a plurality of flange connecting structures;
pivotally connecting said plurality of arm segment pairs, each said arm segment pair comprising a first arm segment and a second arm segment; and
pivotally attaching each of said first arm segment and each said second arm segment to each of said plurality of flange connecting structures.

20. The method of claim 20 further comprising the step of utilizing a plastic hinge pin for attaching the folding core arms to the flanges.
